(19) United States
(12) Patent Application Publication
(10) Pub. No.: US 2017/0248181 A1
(43) Pub. Date: Aug. 31, 2017

(54) PISTON POSITION INSTALLATION DEVICE OF BRAKE CYLINDER

(71) Applicant: BO CHEN HUNG CO., LTD., Taichung City (TW)

(72) Inventor: MING-YU WANG, Taichung City (TW)

(21) Appl. No.: 15/358,705

(22) Filed: Nov. 22, 2016

(30) Foreign Application Priority Data
Feb. 26, 2016 (TW) 105105844

(51) Int. Cl. F16D 65/00; B25B 27/00; B25B 27/02

(52) U.S. Cl. CPC F16D 65/0043; B25B 27/023; B25B 27/0035

(57) ABSTRACT

A piston position installation device of a brake cylinder is provided, including: a main rod, having a first driving portion and a first threaded section along an axial direction and toward the first driving portion, the main rod having an interior hole with a second threaded section, screwing directions of the first and second threaded section being counter to each other; an abutting rod, having a second driving portion, a restricting portion and an exterior threaded portion screwed with the second threaded section, rotatably arranged within the interior hole; a force exerting member, having first and second force exerting portions, the first and second force exerting portions being arranged on the first driving portion and the second driving portion, respectively; a socket, screwed with a first threaded section of the main rod; a blocking board, laterally outwardly protrusive from the socket.

### BACKGROUND OF THE INVENTION

Field of the Invention

The present invention relates to a brake cylinder, and more particularly to a piston position installation device of a brake cylinder.

Description of the Prior Art

As disclosed in TWM435344, an adjuster of a brake cylinder is provided, a toolbox has to driving wrenches, one of the two driving wrenches includes a right-hand thread, and the other of the two driving wrenches includes a left-hand thread for being respectively used to adjust the brake cylinders on the left and right sides. However, with the two driving wrenches in the toolbox, it is more expensive to purchase and manufacture the toolbox, and toolbox which is heavy is difficult to be carried around.

In addition, another type of adjuster of the brake cylinder is disclosed in FIG. 2 of TWM435344, two end portions of the driving wrench respectively have a right-hand threaded section and a left-hand threaded section to cooperate with a wrench plate for adjusting the brake cylinders on the left and right sides of an automobile. However, it is more costly to manufacture the driving wrench since the driving wrench has greater length, and it takes more time to process the threads.

The present invention has arisen to mitigate and/or obviate the afore-described disadvantages.

### SUMMARY OF THE INVENTION

The major object of the present invention is to provide a piston position installation device of a brake cylinder, in which a main rod having a first threaded section and a second threaded section which have opposite screwing directions, the first and second threaded sections are respectively for being screwed with a socket and an abutting rod so as to be used on brake cylinders on the left and right sides of an automobile.

To achieve the above and other objects, a piston position installation device of a brake cylinder is provided, including: a main rod, one of two ends thereof having a first driving portion, the other of the two ends thereof having a first threaded section along an axial direction of the main rod and toward the first driving portion, the main rod having an interior hole, the interior hole having a second threaded section which is arranged along the axial direction, screwing directions of the second threaded section and the first threaded section being counter to each other; an abutting rod, one of two ends thereof having a second driving portion, the other of the two ends thereof having a restricting portion, the abutting rod further having an exterior threaded portion screwed with the second threaded section, and the abutting rod being rotatably arranged within the interior hole; a force exerting member, having a first force exerting portion and a second force exerting portion, the first force exerting portion being arranged on the first driving portion, the second force exerting portion being arranged on the second driving portion; a socket, screwed with a first threaded section of the main rod; a blocking board, laterally outwardly protrusive from the socket.

The first threaded section includes a left-hand thread, and the second threaded section includes a right-hand thread.

Thereby, when the first force exerting portion of the force exerting member is arranged on the first driving portion to drive the main rod, an installation operation of a piston of the brake cylinder on the right side of the brake cylinder is conducted; and when the second force exerting portion of the force exerting member is arranged on the second driving portion to drive the abutting rod, an installation operation of a position of a piston of the brake cylinder on the left side of the brake cylinder is conducted. Therefore, there is no need of two sets of installation devices to adjust the brake cylinders on the left and right sides of the automobile, and the piston position installation device of the brake cylinder is less costly to be manufactured and purchased and is lighter to be carried around.

Furthermore, an outer periphery and an inner periphery of the main rod respectively have the first threaded section and the second threaded section which have the opposite screwing directions for being screwed with the socket and the abutting rod, so a total length is decreased, and a manufacturing cost is lowered.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a drawing showing the present invention;

FIG. 2 is a breakdown view of the present invention;

FIG. 3 is a drawing showing the present invention assembled to a driving plate;

FIG. 4 is a drawing showing the present invention used on a brake cylinder on a left side of an automobile;

FIG. 5 is a cross-sectional view of the present invention used on the brake cylinder on the left side of the automobile, showing a force exerting member driving a main rod;

FIG. 6 is a drawing showing the present invention used on the brake cylinder on a right side of the automobile; and

FIG. 7 is a cross-sectional view of the present invention used on the brake cylinder on the right side of the automobile, showing the force exerting member driving the main rod.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

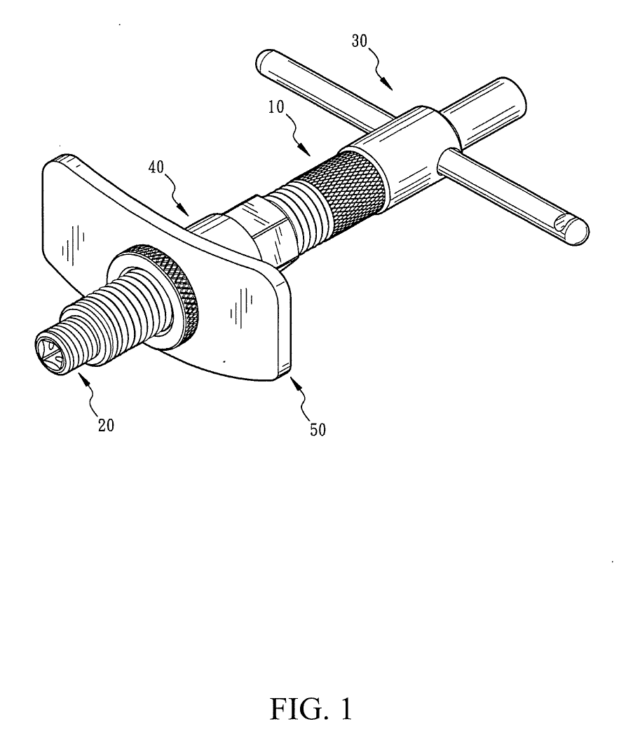

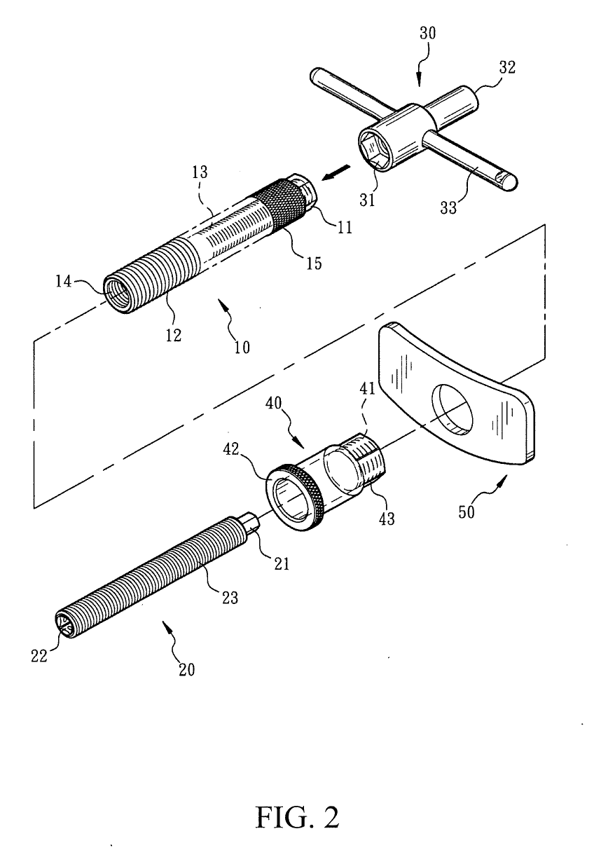

Please refer to FIGS. 1 to 7 for a piston position installation device of a brake cylinder, including a main rod 10, an abutting rod 20, a force exerting member 30, a socket 40 and a blocking board 50.

One of two ends of the main rod 10 has a first driving portion 11, and the other of the two ends of the main rod 10 has a first threaded section 12 along an axial direction of the main rod 10 and toward the first driving portion 11. The first driving portion 11 is hexagonal, and the first threaded section 12 includes a left-hand thread. Specifically, the main rod 10 has an interior hole 13, the interior hole 13 has a second threaded section 14 which is arranged along the axial direction, and the second threaded section 14 includes a right-hand thread which is counter to that of the first threaded section 12. In addition, a length of the first threaded section 12 is equal to or greater than a half of a length of the main rod 10, and a frictional section 15 is disposed between the first driving portion 11 and the first threaded section 12 so that a user can grip on the main rod 10 firmly.

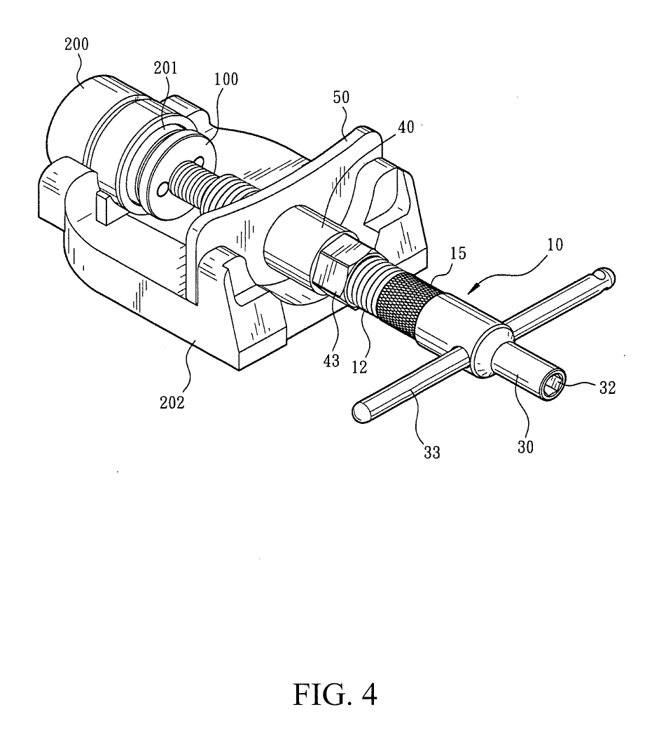

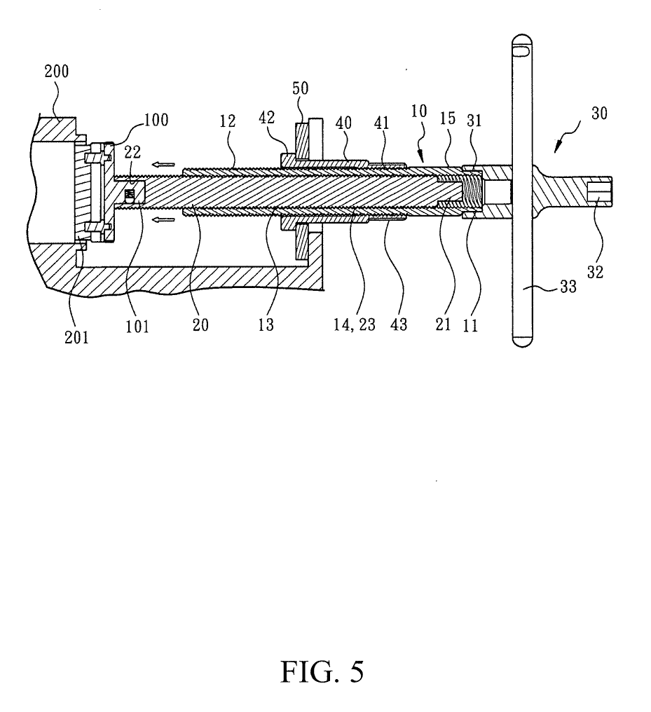

One of two ends of the abutting rod 20 has a second driving portion 21, and the other of the two ends of the abutting rod 20 has a restricting portion 22. The abutting rod 20 further has an exterior threaded portion 23 screwed with the second threaded section 14 of the main rod 10, and the abutting rod 20 is rotatably arranged within the interior hole 13 of the main rod 10. Specifically, the second driving portion 21 of the abutting rod 20 is smaller than the first driving portion 11 in exterior diameter, and the second driving portion 21 is hexagonal. More specifically, the restricting portion 22 is a square hole for being engaged with an engaging portion 101 of a driving plate 100 so as to be connected to a brake cylinder 200 (as shown in FIGS. 4 and 5).

The force exerting member 30 has a first force exerting portion 31 and a second force exerting portion 32, the first force exerting portion 31 is arranged on the first driving portion 11, and the second force exerting portion 32 is arranged on the second driving portion 21. The first and second force exerting portions 31, 32 are arranged on two ends of the force exerting member 30 and toward opposite directions. In addition, the force exerting member 30 has a force exerting rod 33 which is laterally and slidably disposed therethrough, and the force exerting rod 33 is arranged between the first force exerting portion 31 and the second force exerting portion 32. The first force exerting portion 31 and the second force exerting portion 32 of the force exerting member 30 are respectively hexagonal holes for being optionally sleeved on the first driving portion 11 and the second driving portion 12, and the first driving portion 11 and the second driving portion 12 are driven by the force exerting rod 33.

The socket 40 is screwed with a first threaded section 12 of the main rod 10. In this embodiment, the socket 40 has a screwing hole 41 for being screwed with the first threaded section 12. One of two ends of the socket 40 has a ring portion 42, an outer periphery of the ring portion 42 has a frictional pattern, the other of the two ends of the socket 40 has a rotating portion 43, and the rotating portion is hexagonal for a tool to drive the socket 40 so that the socket 40 can move relative to the main rod 10.

The blocking board 50 is laterally outwardly protrusive from the socket. Specifically, the socket 40 is disposed through the blocking board 50. The blocking board 50 and the socket 40 may be integrally formed, and the blocking board 50 extends integrally from the socket 40.

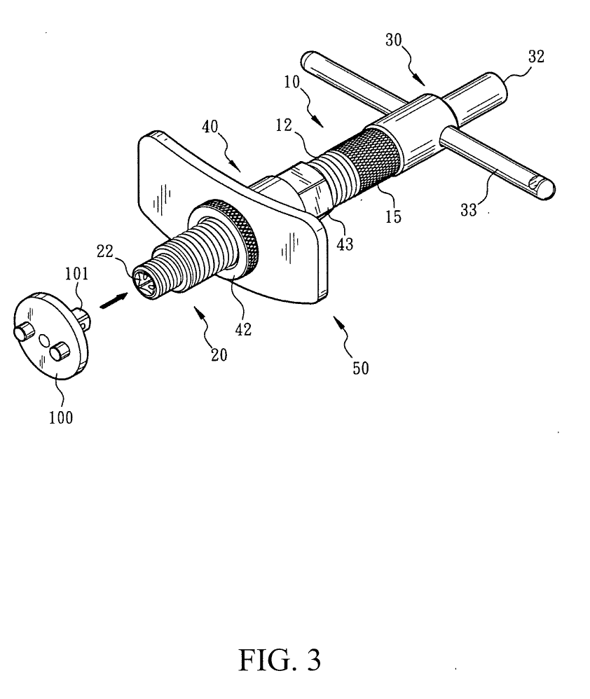

Please refer to FIG. 3, when using the piston position installation device of the brake cylinder, the user need d to choose the driving plate 100 in an appropriate dimension and assemble the driving plate on the restricting member 22 of the abutting rod 20 for further operation.

Please refer to FIGS. 4 and 5, the blocking board 50 is arranged on an inner side of a restricting base 202 of the brake cylinder 200 on the left side, the driving plate 100 is connected to the piston 201 of the brake cylinder 200, the socket 40 is arranged on the restricting base 202, the ring portion 42 is arranged on a side of the blocking board 50 opposite to the socket 40. The first force exerting portion 31 of the force exerting member 30 is sleeved on the first driving portion 11 of the main rod 10, the main rod 10 is driven through the force exerting rod 33 being operated counterclockwise, and the main rod 10 moves toward a left-hand side relative to the socket 40 so as to use the driving plate 100 to press the piston 201 of the brake cylinder 200 back to an original position and finish an adjusting operation of the brake cylinder 200 on a left side of an automobile.

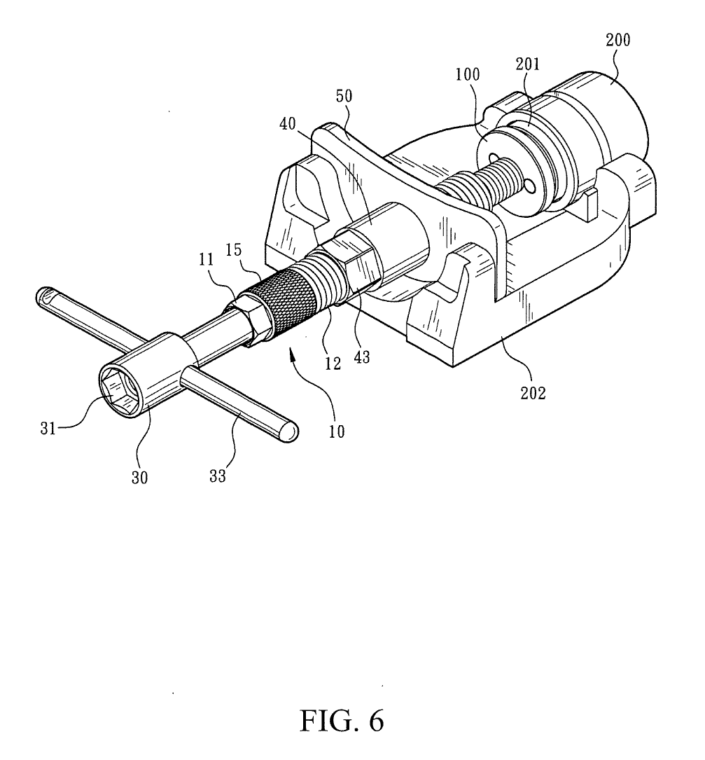

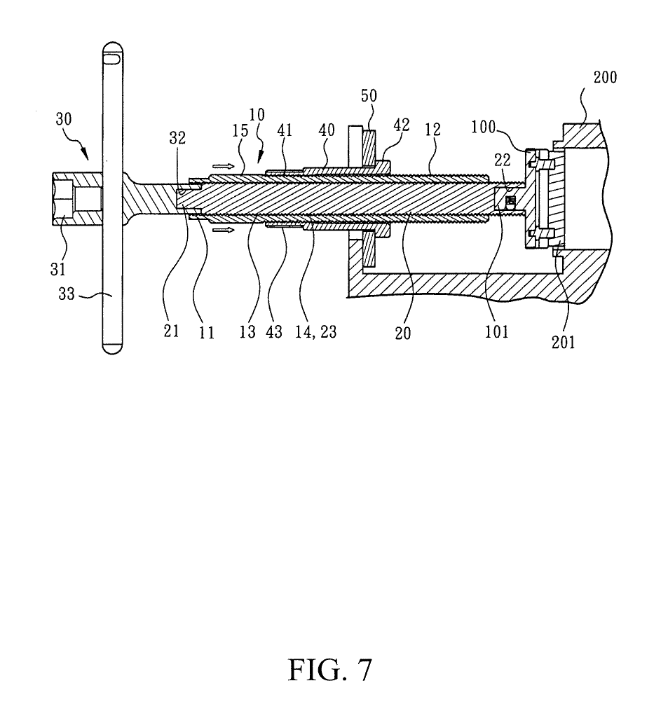

Please refer to FIGS. 6 and 7, when the piston position installation device is assembled on the brake cylinder 200, the second force exerting portion 32 of the force exerting member 30 is sleeved on the second driving portion 21 of the abutting rod 20, the abutting rod 20 is driven through the force exerting rod 33 being operated clockwise, and the abutting rod 20 moves toward a right-hand side relative to the main rod 10 so as to use the driving plate 100 to press the piston 201 of the brake cylinder 200 back to the original position and finish an adjusting operation of the brake cylinder 200 on a right side of the automobile.

Thereby, the piston position installation device can be used in installation operations of the brake cylinders 200 on the left and right sides of the automobile. The first threaded section 12 on an outer periphery of the main rod 10 and the second threaded section 14 on an inner periphery of the main rod 10 are respectively for the socket 40 and the abutting rod 20 to be screwed therewith so as to decrease an arrangement length of a threaded section on a same axis and further to decrease a total length of the piston position installation device to lower a manufacturing cost.

While we have shown and described various embodiments in accordance with the present invention, it should be clear to those skilled in the art that further embodiments may be made without departing from the scope of the present invention.

What is claimed is:

1. A piston position installation device for a brake cylinder, including:
a main rod, one of two ends thereof having a first driving portion, the other of the two ends thereof having a first threaded section along an axial direction of the main rod and toward the first driving portion, the main rod having an interior hole, the interior hole having a second threaded section which is arranged along the axial direction, screwing directions of the second threaded section and the first threaded section being counter to each other;
an abutting rod, one of two ends thereof having a second driving portion, the other of the two ends thereof having a restricting portion, the abutting rod further having an exterior threaded portion screwed with the second threaded section, and the abutting rod being rotatably arranged within the interior hole;
a force exerting member, having a first force exerting portion and a second force exerting portion, the first force exerting portion being arranged on the first driving portion, the second force exerting portion being arranged on the second driving portion;
a socket, screwed with a first threaded section of the main rod;
a blocking board, laterally outwardly protrusive from the socket.

2. The piston position installation device of the brake cylinder of claim 1, wherein the first threaded section includes a left-hand thread, and the second threaded section includes a right-hand thread.

3. The piston position installation device of the brake cylinder of claim 1, wherein the force exerting member has a force exerting rod which is laterally and slidably disposed therethrough.

4. The piston position installation device of the brake cylinder of claim 3, wherein the first and second force exerting portions are arranged toward opposite directions.

5. The piston position installation device of the brake cylinder of claim 1, wherein the first driving portion is hexagonal, and the first force exerting portion is a hexagonal hole.

6. The piston position installation device of the brake cylinder of claim 1, wherein the second driving portion is hexagonal, and the second force exerting portion is a hexagonal hole.

7. The piston position installation device of the brake cylinder of claim 1, wherein the restricting portion is a square hole.

8. The piston position installation device of the brake cylinder of claim 1, wherein one of two ends of the socket has a ring portion.

9. The piston position installation device of the brake cylinder of claim 8, wherein the other of the two ends of the socket has a rotating portion.

10. The piston position installation device of the brake cylinder of claim 8, wherein an outer periphery of the ring portion has a frictional pattern.

11. The piston position installation device of the brake cylinder of claim 9, wherein the rotating portion is hexagonal.

12. The piston position installation device of the brake cylinder of claim 1, wherein a length of the first threaded section is equal to or greater than a half of a length of the main rod.

13. The piston position installation device of the brake cylinder of claim 1, wherein a frictional section is disposed between the first driving portion and the first threaded section.
